(19) United States
(12) Patent Application Publication
(10) Pub. No.: US 2025/0342683 A1
(43) Pub. Date: Nov. 6, 2025

(54) VISION FOUNDATION MODEL FOR MULTIMODE IMAGING

(71) Applicant: KLA Corporation, Milpitas, CA (US)

(72) Inventors: Jing Zhang, Santa Clara, CA (US); Xiu Zhang, Millbrae, CA (US); Yang Li, San Jose, CA (US); Yujie Dong, Newark, CA (US); Sangbong Park, Danville, CA (US); Atiqur Rahman Chowdhury, San Jose, CA (US)

(21) Appl. No.: 19/051,999

(22) Filed: Feb. 12, 2025

Related U.S. Application Data
(60) Provisional application No. 63/641,941, filed on May 2, 2024.

(51) Int. Cl. G06V 10/77; G06T 7/00; G06V 10/26; G06V 10/764; G06V 10/774

(52) U.S. Cl. CPC G06V 10/7715; G06T 7/0004; G06V 10/26; G06V 10/764; G06V 10/7753; G06T 2207/30148

(57) ABSTRACT

Methods and systems for determining information for a specimen are provided. One system includes a computer system and one or more components executed by the computer system. The one or more components include a pre-trained vision foundation model (VFM) configured for projecting multiple images for a specimen to high dimensional embeddings via continuous pretraining. The multiple images include an image generated for the specimen with one or more modes of an imaging system. The one or more components also include one or more additional components configured for determining information for the specimen from the high dimensional embeddings.

### BACKGROUND OF THE INVENTION

### 1. Field of the Invention

The present invention generally relates to methods and systems for determining information for a specimen. Certain embodiments relate to methods and systems that include or use a vision foundation model (VFM) for projecting multiple images, at least one of which is generated with one or more modes of an imaging system, for a specimen to high dimensional embeddings that are then used to determine information for the specimen.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Even after suitable hardware parameters have been established for the yield related processes described above, methods and systems for determining specimen information from the tool output can still be challenging. Increasingly, deep learning (DL) options are being explored as potential solutions for determining information from images and/or other output of the tools described above. Some examples of such DL options include vision transformer (ViT) based solutions configured, for example, as described by Dosovitskiy et al., “An Image is Worth 16×16 Words: Transformer for Image Recognition at Scale,” published as a conference paper at ICLR 2021, arXiv:2010.11929v2, Jun. 3, 2021, 22 pages, and Swin Transformers such as those described by Liu et al., “Swin Transformer: Hierarchical Vision Transformer using Shifted Windows,” arXiv:2103.14030v2, Aug. 17, 2021, 14 pages, both of which are incorporated by reference as if fully set forth herein. Additional examples of DL options include convolutional neural network (CNN) based solutions, which may be configured for functions such as, but not limited to, stacking inputs, averaging pooling, or other more complex fusion methods like attention mechanisms.

While the above-described DL options may be suitable in some circumstances, they have been found to be limited in some ways. For example, ViT can only be applied to single RGB (or color) images (e.g., 3 channels and 8 bits per channel) and cannot be used in arbitrary numbers of multimode imaging. Similarly, Swin transformers can only be applied to single RGB images and cannot be used in arbitrary numbers of multimode images.

CNN based solutions also have a number of disadvantages. For example, CNN based solutions that stack inputs have a limited ability to learn the multimode information (vs. transformers). In addition, averaging pooling will often lose information during the pooling process, resulting in limited capability of learning multimode information that limits the sensitivity. Fusion methods like stacking also have limited ability to learn the information from each of the modes. In general, CNN based solutions show lower performance (sensitivity or accuracy) compared with transformer-based solutions.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for determining information for a specimen. The system includes a computer system and one or more components executed by the computer system. The one or more components include a pre-trained vision foundation model (VFM) configured for projecting multiple images for a specimen to high dimensional embeddings via continuous pretraining. The multiple images include an image generated for the specimen with one or more modes of an imaging system. The one or more components also include one or more additional components configured for determining information for the specimen from the high dimensional embeddings. The system may be further configured as described herein.

Another embodiment relates to a computer-implemented method for determining information for a specimen. The method includes inputting multiple images for a specimen into a pre-trained VFM configured for projecting the multiple images to high dimensional embeddings via continuous pretraining. The multiple images include an image generated for the specimen with one or more modes of an imaging system. The method also includes determining information for the specimen from the high dimensional embeddings. The inputting and determining are performed by a computer system. One or more components are executed by the computer system. The one or more components include the pre-trained VFM. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a block diagram illustrating an embodiment of a configuration of one or more components that include a vision foundation model (VFM);

FIG. 4 is a block diagram illustrating an embodiment of a configuration of one or more components that include a latent VFM (LVFM); and

FIG. 5 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for determining information for a specimen. In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

Generally, for a given wafer, each mode of an inspection tool (or other quality-control related tool described herein) captures unique information due to wafer material, design pattern, and the variations of process control and conditions. Methods that only support a fixed or substantially limited number of modes are not optimal considering the information loss. The embodiments described herein solve the problem by designing generative artificial intelligence (GenAI) based systems and methods that are capable of learning from arbitrary number of modes data (including the option of all modes) to benefit the downstream applications.

The embodiments described herein include or use a vision foundation model (VFM) for determining information for a specimen. The embodiments described herein use a VFM on wafer or reticle imaging to learn the visual representation of the images collected on a semiconductor inspection or metrology tool based on a given light or electron beam source. The embodiments construct the VFM to be capable of learning on imaging data such as multimode optical or other imaging data (e.g., collected on the 39xx series of tools commercially available from KLA Corp., Milpitas, Calif.) and how to apply the multimode-capable VFM to downstream applications including, but not limited to, defect detection and digital twin of wafer or reticle manufacturing processes.

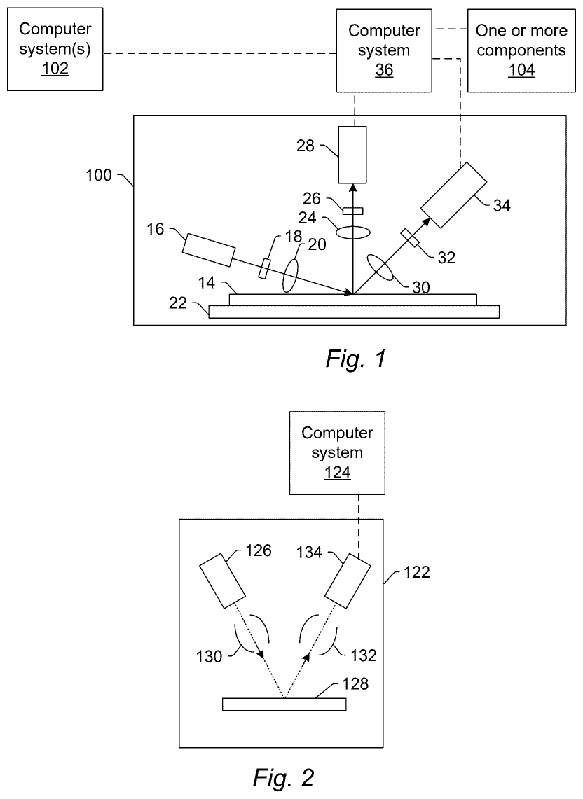

One embodiment of a system configured for determining information for a specimen is shown in FIG. 1. The system includes a computer system, e.g., computer system 36 and/or one or more computer systems 102. In some embodiments, the system includes imaging system 100, which may be configured as one of the types of imaging systems described herein such as an inspection, metrology, or defect review subsystem, which may include and/or be coupled to computer system 36 and/or one or more computer systems 102.

The terms “imaging system” and “imaging subsystem” are used interchangeably herein and generally refer to any of the hardware configured for generating images of a specimen. In general, the imaging systems described herein include at least an energy source and a detector. The energy source is configured to generate energy that is directed to a specimen. The detector is configured to detect energy from the specimen and to generate output responsive to the detected energy.

In a light-based imaging system, the energy directed to the specimen includes light, and the energy detected from the specimen includes light. For example, as shown in FIG. 1, the imaging system includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen, the characteristics of the specimen to be measured, etc.

The illumination subsystem may be configured to direct the light to the specimen at different angles of incidence. For example, the imaging system may be configured to alter one or more parameters of one or more elements of the illumination subsystem such that the light can be directed to the specimen at an angle of incidence that is different than that shown in FIG. 1. In one such example, the imaging system may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging system may also include a scanning subsystem configured to change the position on the specimen to which the light is directed and from which the light is detected and possibly to cause the light to be scanned over the specimen. For example, the imaging system may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging system may be configured such that one or more optical elements of the imaging system perform some scanning of the light over the specimen such that the light can be directed to and detected from different positions on the specimen. The light may be scanned over the specimen in any suitable fashion such as in a serpentine-like path or in a spiral path.

The imaging system includes one or more detection channels. At least one of the detection channel(s) includes a detector configured to detect light from the specimen due to illumination of the specimen by the system and to generate output responsive to the detected light. The imaging system shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging system that includes two detection channels, the imaging system may include a different number of detection channels (e.g., only one detection channel or two or more detection channels). The detection channel formed by collector 30, element 32, and detector 34 may form one side channel as described above, and the imaging system may include an additional detection channel (not shown) formed as another side channel that is positioned on the opposite side of the plane of incidence. Therefore, the imaging system may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging system may also include two or more side channels configured as described above. As such, the imaging system may include at least three channels (i.e., one top channel and two side channels), and each of the at least three channels is configured to collect light at different scattering angles than each of the other collectors.

As described further above, one or more of the detection channels may be configured to detect scattered light. Therefore, the imaging system shown in FIG. 1 may be configured for dark field (DF) imaging. However, the imaging system may also or alternatively include detection channel(s) that are configured for bright field (BF) imaging. Therefore, the imaging systems described herein may be configured for only DF, only BF, or both DF and BF imaging. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the light such as intensity but may not be configured to detect such characteristics as a function of position within the imaging plane. As such, the output that is generated by each of the detectors in each of the detection channels may be signals or data, but not image signals or image data. In such instances, a computer system may be configured to generate images of the specimen from the non-imaging output of the detectors. However, in other instances, the detectors may be configured as imaging detectors that are configured to generate imaging signals or image data. Therefore, the imaging system may be configured to generate images in a number of ways.

Computer system 36 may be coupled to the detectors of the imaging system in any suitable manner (e.g., via one or more transmission media, which may include “wired” and/or “wireless” transmission media) such that the computer system can receive the output generated by the detectors. Computer system 36 may be configured to perform a number of functions using the output of the detectors as described further herein. Computer system 36 may be further configured as described herein.

Computer system 36 (as well as other computer systems described herein) may also be referred to herein as computer subsystem(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer system, then the different computer systems may be coupled to each other such that images, data, information, instructions, etc. can be sent between the computer systems. For example, computer system 36 may be coupled to computer system(s) 102 as shown by the dashed line in FIG. 1 by any suitable transmission media, which may include any suitable wired and/or wireless transmission media known in the art. Two or more of such computer systems may also be effectively coupled by a shared computer-readable storage medium (not shown).

In an electron beam imaging system, the energy directed to the specimen includes electrons, and the energy detected from the specimen includes electrons. In one such embodiment shown in FIG. 2, the imaging system includes electron column 122, and the system includes computer system 124 coupled to the imaging system. Computer system 124 may be configured as described above. In addition, such an imaging system may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging system may be configured to use multiple modes to generate output for the specimen as described further herein (e.g., with different illumination angles, collection angles, etc.). The multiple modes of the electron beam imaging system may be different in any output generation parameters of the imaging system.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to perform any step(s) described herein. A system that includes the imaging system shown in FIG. 2 may be further configured as described herein.

FIGS. 1 and 2 are provided herein to generally illustrate configurations of an imaging system that may be included in the system embodiments described herein. Obviously, the imaging system configurations described herein may be altered to optimize the performance of the imaging system as is normally performed when designing a commercial imaging system. In addition, the systems described herein may be implemented using an existing imaging system (e.g., by adding functionality described herein to an existing inspection system) such as the tools that are commercially available from KLA Corp., Milpitas, Calif. For some such systems, the methods described herein may be provided as optional functionality of the imaging system (e.g., in addition to other functionality of the imaging system). Alternatively, the imaging system described herein may be designed “from scratch” to provide a completely new system.

Although the imaging system is described above as being a light or electron beam imaging system, the imaging system may be an ion beam imaging system. Such an imaging system may be configured as shown in FIG. 2 except that the electron beam source may be replaced with any suitable ion beam source known in the art. In addition, the imaging system may include any other suitable ion beam system such as those included in commercially available focused ion beam (FIB) systems, helium ion microscopy (HIM) systems, and secondary ion mass spectroscopy (SIMS) systems.

The imaging system may be configured to generate output, e.g., images, of the specimen with multiple modes. In general, a “mode” is defined by the values of parameters of the imaging system used for generating images of a specimen (or the output used to generate images of the specimen). Therefore, modes may be different in the values for at least one of the parameters of the imaging system (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the imaging system. The imaging system may be configured to scan the specimen with the different modes in the same scan or different scans, e.g., depending on the capability of using multiple modes to scan the specimen at the same time.

In a similar manner, the electron beam system may be configured to generate images with two or more modes, which can be defined by the values of parameters of the electron beam system used for generating images for a specimen. Therefore, modes may be different in the values for at least one of the electron beam parameters of the electron beam system. For example, different modes may use different angles of incidence for illumination.

The imaging systems described herein may be configured as an inspection system, a metrology system, and/or a defect review system. For example, the embodiments of the imaging system shown in FIGS. 1 and 2 may be modified in one or more parameters to provide different imaging capability depending on the application for which it will be used. In one such example, the imaging system may be configured to have a higher resolution if it is to be used for metrology rather than for inspection. In other words, the embodiments of the imaging system shown in FIGS. 1 and 2 describe some general and various configurations for an imaging system that can be tailored in a number of manners that will be obvious to one skilled in the art to produce systems having different imaging capabilities that are more or less suitable for different applications.

In this manner, the imaging system may be configured for generating output that is suitable for detecting or re-detecting defects on the specimen in the case of an inspection system or a defect review system, respectively, and for measuring one or more characteristics of the specimen in the case of a metrology system. In an inspection system, computer system 36 shown in FIG. 1 may be configured for detecting defects on specimen 14 by applying a defect detection method or algorithm to output generated by one or more of the detectors. In a defect review system, computer system 124 shown in FIG. 2 may be configured for re-detecting defects on specimen 128 by applying a defect re-detection method to the output generated by detector 134 and possibly determining additional information for the re-detected defects using the output generated by the detector. In a metrology system, computer system 36 shown in FIG. 1 may be configured for determining one or more characteristics of specimen 14 using the output generated by detectors 28 and/or 34. However, the system may be configured for detecting or re-detecting defects on the specimen, determining characteristics of the specimen, determining other information for the specimen, etc. as described further herein.

As noted above, the imaging system is configured for scanning energy (e.g., light, electrons, etc.) over a physical version of the specimen thereby generating output for the physical version of the specimen. In this manner, the imaging system may be configured as an “actual” subsystem, rather than a “virtual” subsystem. However, a storage medium (not shown) and computer system(s) 102 shown in FIG. 1 may be configured as a “virtual” system. In particular, the storage medium and the computer system(s) may be configured as a “virtual” imaging system as described in commonly assigned U.S. Pat. No. 8,126,255 issued on Feb. 28, 2012 to Bhaskar et al. and 9,222,895 issued on Dec. 29, 2015 to Duffy et al., which are incorporated by reference as if fully set forth herein. The embodiments described herein may be further configured as described in these patents.

The system includes a computer system, which may include any configuration of any of the computer subsystem(s) or system(s) described above, and one or more components executed by the computer system. For example, as shown in FIG. 1, the system may include computer system 36 and one or more components 104 executed by the computer system. The one or more components include a pre-trained VFM configured for projecting multiple images for a specimen to high dimensional embeddings via continuous pretraining.

The computer system may be configured for inputting the multiple images into the pre-trained VFM in any suitable manner known in the art. The computer system or the one or more components may also acquire the images in any suitable manner. For example, the computer system may acquire the images by causing an imaging system to generate the images, e.g., by scanning the specimen as described herein. The computer system may also or alternatively acquire the images from a storage medium in which the images have been stored, e.g., by another computer system, by the imaging system, etc.

In this manner, the images that are input to the VFM may be generated by the embodiments described herein or acquired from another method or system that generated the images.

The pre-trained VFM can be generally defined as a deep learning (DL) model that is pre-trained on a preferably massive and highly diverse training data set and therefore can be used in different domains and different datasets. For example, in the embodiments described herein, the different domains and different datasets that are used to pre-train the VFM may include images and/or other output generated by the imaging systems and/or computer systems described herein for different specimens. The training data set may preferably include images and/or other specimen information generated with more than one mode of at least one imaging system. Such training data is preferred in the embodiments described herein since a significant advantage of the embodiments described herein is their ability to handle multi-mode images or data, which currently used DL models are not capable of doing. The training data may also include images and/or specimen information generated for different kinds of specimens, e.g., wafers at different levels, different kinds of wafers, wafers at different points in a fabrication process, etc. The training data may also include images and/or specimen information generated from different imaging systems, which may include different tools that are of the same make and model, i.e., different instances of the same tool configuration, or tools that have different configurations, e.g., different inspection systems that have different configurations. In addition to the training data described above, a training data set for the embodiments described herein may include images from other domains such as natural scene images, images of specimens other than wafers and reticles, and the like.

VFMs are referred to as foundation models because they provide a base or foundation that has been built and can be adapted to different uses and domains. In other words, the VFMs can be used to perform specific tasks without a bespoke model that is trained with data specific to the tasks. In this manner, VFMs generalize the representational learning capabilities inherent in DL models across different tasks. VFMs have representational learning capabilities in the sense that they learn to represent visual information in a way that provides meaningful output to downstream tasks such as those described further herein.

The continuous pretraining of the pre-trained VFM refers to the fact that after initial training, the VFM can be continuously fine-tuned or modified for specific tasks and domains. In other words, a VFM does not need to be created from scratch and pre-trained for each of the possible uses described herein, and instead the same pre-trained VFM can be reused via the continuous pretraining that can be performed to fine-tune the VFM for specific inputs and uses. A significant advantage to the VFM capability is that the continuous pretraining that effectively fine tunes the pre-trained VFM can be performed with a significantly smaller amount of images and/or specimen information.

As mentioned above, the pre-trained VFM in the system projects multiple images to high dimensional embeddings. Therefore, the pre-trained VFM may be referred to as an “embedding extractor” type of foundation model. Generally, such DL models transform the inputs, in this case the multiple images, into more compact and condensed vector representations that are commonly referred to as embeddings. The way that embedding extractors transfer knowledge from a pre-trained phase to a specific task is that during pre-training, the embedding extractor learns to identify different features or characteristics in the images and/or specimen information that could be useful in different domains. These features can include relatively simple features like edges and colors to more complex ones such as shapes, textures, object parts, etc. The VFM transfers the knowledge learned during the pretraining phase to the runtime phase by the fine-tuning or VFM modification described herein. The pretraining and fine-tuning may be performed as described further herein.

The term “high dimensional embeddings” refers to the dimensionality of the vector embeddings into which the images are projected by the pre-trained VFM. In general, the “dimension” of an embedding can be defined as the number of elements in a vector that represents, in this case, an image. In other words, an embedding that has 1000 dimensions represents an image with a vector that has 1000 elements. The dimensionality of the embeddings can vary from use case to use case, e.g., input to input. For example, a dimensionality that is too high for one type of specimen image because it captures noise instead of or in addition to important information in the specimen image can result in overfitting of the pre-trained VFM and/or decreased performance of the downstream tasks described herein. However, the same dimensionality may be fine for other types of specimen images that have less noise. In addition, the dimensionality of the embeddings will generally be different for different sizes of input images—higher dimensionality embeddings for larger input images and smaller dimensionality embeddings for smaller input images.

The embodiments described herein project images into “high” dimensional embeddings even though the projecting performed by the pre-trained VFM is a form of dimension reduction. For example, an image patch grabbed by an imaging system for inspection purposes may be, say, 256 pixels by 256 pixels as just one non-limiting example. In that case, the dimensionality of the image patch input to the pre-trained VFM is larger than 65,000. If the pre-trained VFM extracts embeddings with high dimensions of, say, 1,000, that is significantly (65 times) lower than the input dimensionality. Therefore, the transformation performed by the pre-trained VFM converts the much larger input vectors of the input image to fewer, but still a large number of, feature vectors or embeddings. In this manner, a “high” dimensional embedding as that term is used herein can be defined as an embedding having more than 100 dimensions, which can be substantially larger for the reasons described above.

The multiple images include an image generated for the specimen with one or more modes of an imaging system. In one embodiment, the multiple images also include multi-mode images generated for the specimen with multiple modes of the imaging system. In the pretraining phase as well as the runtime phase, the input to the VFM may include multi-mode images. For example, the embodiments described herein are advantageously configured for learning from arbitrary number of modes data (including the option of all modes) to benefit the downstream applications. The mode(s) that are used to generate the images for pretraining may be different from the mode(s) that are used for generating the runtime images, which is one of the advantages of the VFMs described herein. In addition, the number of modes used to generate images for pretraining the VFM may be substantially larger than the number of modes used for fine-tuning or adapting the pre-trained VFM and/or used for runtime generation of embeddings for one or more of the downstream tasks described herein. The multiple images may be generated with any of the modes of any of the imaging systems described herein.

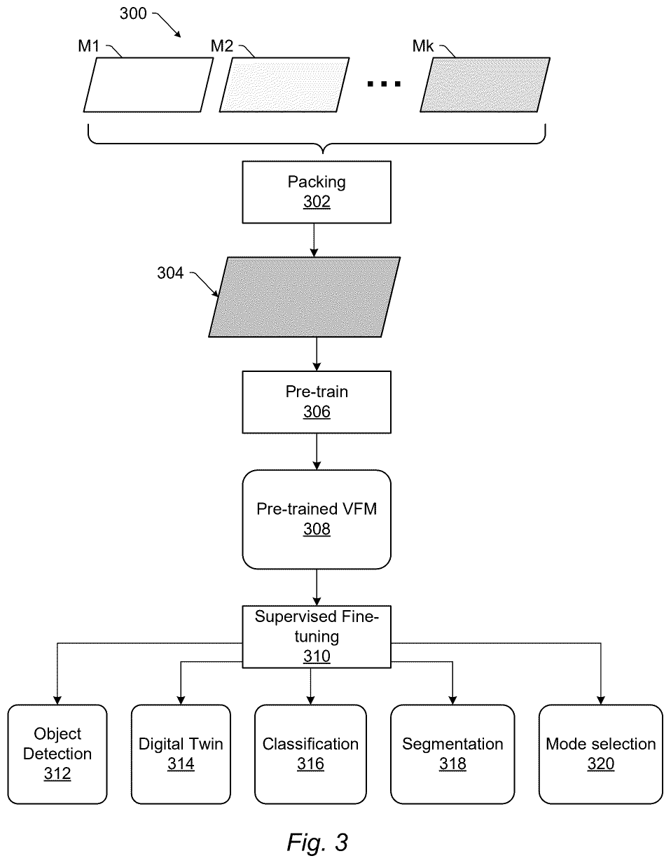

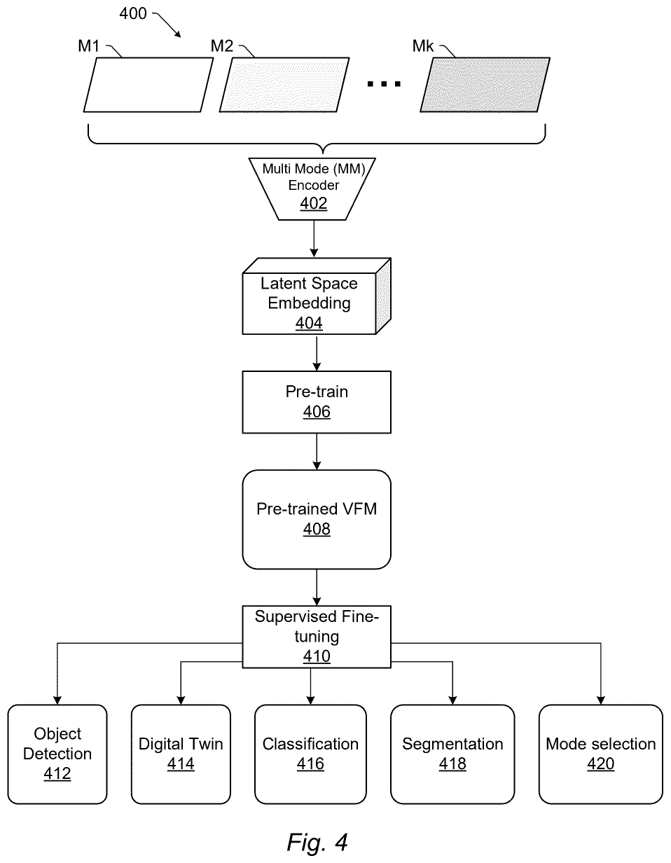

The pre-trained VFM described herein may have different configurations, one of which does not allow inputs in non-image formats, while the other has no constraints for the format of the inputs. For example, in one embodiment, the pre-trained VFM is configured for accepting only inputs in image formats. More specifically, the VFM configuration shown in FIG. 3 only accepts inputs in image formats while the VFM configuration shown in FIG. 4 has no constraints for the format of the inputs such as other process parameters. In general, however, the actual architecture used for the pre-trained VFM may vary significantly from use case to use case, and the pre-trained VFM may have any suitable DL model or neural network architecture.

In some embodiments, the multiple images include the image generated for the specimen with one or more modes of the imaging system and at least one image generated from design data for the specimen. In one such embodiment, the image generated for the specimen with the one or more modes of the imaging system and at least one image generated from the design data for the specimen are generated for the same layer of the specimen. In another such embodiment, the image generated for the specimen with the one or more modes of the imaging system and the at least one image generated from the design data for the specimen are generated for different layers on the specimen. In other words, the multiple images may include images generated for the same layer on a specimen with one or more modes, but the multiple images are also not so limited. For example, in addition to such images, the multiple images may also include images of the design layer on the specimen, which may include any image generated from design data for the specimen and/or any image generated for a layer of the specimen prior to the currently imaged layer, i.e., any image generated for an underlying layer formed before the uppermost layer on the specimen. The multiple images may also include images for more than one design layer and/or more than one underlying layer.

In another embodiment, the one or more components include an image packing component configured for generating a single image that contains information from the multiple images. In one such embodiment, the multiple images include at least one of an image of a design layer on the specimen and an image of a layer formed on the specimen before a last layer formed on the specimen prior to generation of the image generated with the one or more modes of the imaging system. In another such embodiment, the multiple images include multi-mode images generated for the specimen with multiple modes of the imaging system. Such images may include any of the images described above generated as described herein.

As shown in FIG. 3, for example, one of the major components of the VFM is image packing step 302 to generate a single image 304, e.g., a multi-mode (MM) image, that contains all of the information (e.g., the multi-mode information) from the given set 300 of images (e.g., M1, M2, . . . , Mk) from one or more different optical modes (e.g., wavelengths, apertures, focuses, etc.), e.g., an MM stack of at least two multi-mode specimen images, possibly in addition to images for different design layers and/or different prior layers. The image packing component that performs image packing step 302 may have any suitable configuration known in the art. Another major component of the VFM is pre-trained VFM 308 that is configured to project packed image 304 to high dimensional embeddings via continuous pretraining 306. Pre-trained VFM 308 may be configured as described further herein.

The one or more components also include one or more additional components configured for determining information for the specimen from the high dimensional embeddings. For example, an additional major component of the VFM is one or more or even a branch of different downstream heads for different tasks (detection, classification, etc.). In some embodiments, the one or more additional components are configured for learning by supervised fine-tuning. In another embodiment, the one or more additional components are configured for learning by reinforcement learning. For example, the different tasks that are performed by the downstream heads may be learned through supervised fine-tuning (SFT) 310 or reinforcement learning. SFT or reinforcement learning may be performed in any suitable manner known in the art.

In some embodiments, determining the information includes detecting defects on the specimen based on the high dimensional embeddings. For example, the one or more additional components may include object detection downstream head 312. Detecting the defects based on the high dimensional embeddings may be performed in a few different ways. One such way is to compare one or more of the high dimensional embeddings to one or more corresponding high dimensional embeddings determined by the pre-trained VFM for a known defect of interest (DOI). The high dimensional embedding(s) for the known DOI may be generated by acquiring an image of a DOI identified using, for example, a ground truth method or a known, good defect detection method. If the high dimensional embedding(s) for the specimen image match (or match within some predetermined, acceptable limits) the corresponding high dimensional embeddings of the known DOI, then the object detection downstream head may identify that specimen image as containing a defect.

Other ways of using the high dimensional embeddings for defect detection include, but are not limited to, applying a threshold to the high dimensional embedding(s), where high dimensional embedding(s) on one side of the threshold indicate defects and high dimensional embedding(s) on the other side of the threshold do not indicate defects. In another example, the high dimensional embeddings determined for a reference image for the specimen may be subtracted from the high dimensional embeddings determined for the specimen image, and defect detection may be performed based on results of the subtraction, e.g., comparing the results of the subtraction to a threshold.

The high dimensional embeddings may also be input to the defect detection in combination with any other information available for the specimen at that point. For example, the high dimensional embeddings may be input to the defect detection component along with the actual specimen images, one or more reference images, design data, etc. In this manner, defect detection may be performed based on the high dimensional embeddings in the same way that any other specimen images, information, etc. are currently used for defect detection. Furthermore, currently used defect detection algorithms such as the MDAT algorithms that are used by some inspection tools commercially available from KLA may be adapted to use the high dimensional embeddings as input to the algorithms.

In an additional embodiment, determining the information includes generating a digital twin of a manufacturing process performed on the specimen prior to generation of the image generated with one or more modes of the imaging system based on the high dimensional embeddings. For example, the one or more additional components may include digital twin downstream head 314, which may have any suitable configuration known in the art. The digital twin head may be configured for virtualizing or creating a digital twin or 3D physical representation of the specimen from the high dimensional embeddings extracted from the image(s) of the specimen by the pre-trained VFM. Therefore, the digital twin can be used to infer the state of the specimen and also for permutation of one or more characteristics of the digital twin for a number of applications.

In one such example, the dimensions of one or more features in the 3D physical representation may be permutated to examine how the variations affect the inspection or imaging of the specimen and/or how they can manifest as defects on the specimen. For example, the digital twin head may be configured for inclusion of potential sources of variation that may not have an obvious cause and effect at first glance. Much of the work in inspection is to identify aspects of the fabrication process that need to be monitored and controlled better in order to eliminate the sources of the defect mechanisms. Systematic defect sources typically have multiple dependencies on physical parameters that need to be controlled better.

Part of the value for the “digital twin” functionality may also be to predict multi-variate process marginalities and in turn predict what these would look like to an inspector. Similar in concept to “Bayesian priors,” the power of this function is that it enables proactively looking for signatures in optical (or other inspector) data that would otherwise be ignored. In this manner, the 3D physical representation(s) of a specimen with permutated feature dimensions may be input to the mode selection downstream head described further herein.

The digital twin capabilities described herein may also enable design-technology co-optimization (DTCO) experiments to be done in research and development environments. Whereas today these activities are compartmentalized, the embodiments described herein enable a digital twin virtual inspection of a specimen along with real specimen recordings and can run real time experiments of the whole DTCO flow that otherwise takes weeks/months to do physically.

In a further embodiment, determining the information includes classifying defects detected on the specimen based on the high dimensional embeddings. For example, the one or more additional components may include classification downstream head 316. Classification downstream head 316 may be configured for classifying defects in a variety of ways. One such way is to compare the high dimensional embeddings determined for a specimen image to the high dimensional embeddings generated for images of different classes of defects. A defect detected in the specimen image may be assigned a defect classification based on which of the high dimensional embeddings it best matches. Of course, this is perhaps the most simple way that defect classification may be performed based on the high dimensional embeddings and, in the same manner as defect detection described above, the defect classification may be performed in any other manner known in the art using the high dimensional embeddings instead of or in addition to other currently used input. For example, the classification downstream head may be configured to perform defect classification using a decision tree type classifier and the high dimensional embeddings determined for a specimen image may be one of the inputs (or even the only input) to the decision tree.

In some embodiments, determining the information includes segmenting one or more of the multiple images based on the high dimensional embeddings. For example, the one or more additional components may include segmentation downstream head 318. The segmentation downstream head may perform image segmentation in a fairly straightforward way. For example, as described further herein, the pre-trained VFM may transform the specimen image(s) into high dimensional embeddings responsive to image features such as edges, shapes, textures, object parts, etc. The image segmentation may then include mapping the high dimensional embeddings responsive to such image features back to image space and generating information for that mapping. Again, however, this type of image segmentation may be perhaps the most simple manner of doing so, and the high dimensional embeddings may be input to an image segmentation method or algorithm in the same manner as any other specimen image or specimen image information.

In another embodiment, determining the information includes selecting one or more modes of the imaging system for a process performed on the specimen or another specimen based on the high dimensional embeddings. For example, the one or more additional components may include mode selection downstream head 320. The mode selection may be performed in many different ways. One such way is that the high dimensional embeddings determined for images of a specimen generated with different modes may be compared, and the modes that generated images that are more or less responsive to certain features in the images can be identified based on results of the comparisons.

In one such example, if the high dimensional embeddings are responsive to texture in the specimen images, which is in turn responsive to roughness on the specimen that is not of interest to the user, the modes that produced images with the least amount of texture may be identified by comparing the high dimensional embeddings. Those modes may be then be selected for use or further examination since they advantageously are not responsive to roughness on the specimen, which could hinder defect detection, defect re-detection, or characteristic measurement on the specimen. In the same manner, the high dimensional embeddings may be used to identify modes that are less suitable for inspection (or another process) based on texture, which can then be eliminated from further use or consideration.

High dimensional embeddings that are responsive to other useful features may also be used in a similar manner. For example, if the high dimensional embeddings are responsive to shape in the specimen images, the modes that produced images in which the shape is more pronounced may be identified by comparing the high dimensional embeddings for the specimen images generated with different modes. The identified modes may then be selected for use or further examination since they may be more responsive to defect or structure shape than other modes, which can be advantageous for defect detection, defect re-detection, or characteristic measurement. The high dimensional embeddings may be therefore used to identify modes that are more suitable for inspection (or another process), which can then be used to create a recipe as described further herein or used for further examination.

Multiple vectors in the high dimensional embeddings may also be used in combination to identify modes that are of interest and/or modes that are not of interest. For example, an overall score may be generated for each mode indicating how good or bad two or more vectors in the high dimensional embeddings are for that mode (e.g., relative to some predetermined criteria or relative to other high dimensional embeddings determined for other modes). The different modes can then be ranked according to the overall score, and the rankings can be used to identify modes that might be more useful and modes that should be less useful.

In another embodiment, the pre-trained VFM is configured as a pre-trained latent VFM (LVFM) having no constraints on formats of inputs into the pre-trained LVFM. For example, the LVFM shown in FIG. 4, by way of its configuration, has no constraints for the format of the inputs such as other process parameters. Inputs such as process parameters may be acquired from a process recipe for a process that was performed on the specimen such as a lithography, etch, or other fabrication process that are stored in some storage medium.

In an additional embodiment, the one or more components include a multi-image encoder configured for projecting the multiple images into a latent space embedding. In one such embodiment, the multiple images include at least one of information for a design layer on the specimen and information for a layer formed on the specimen before a last layer formed on the specimen prior to generation of the image generated with the one or more modes of the imaging system. The multiple images may include any of such images described further herein.

As shown in FIG. 4, for example, one of the major components of the LVFM is multi-mode (MM) image encoder 402 configured for projecting the set 400 of images (e.g., M1, M2, . . . , Mk) from one or more different optical modes (i.e., an MM stack of images) and optionally different design layers and/or different prior layers into latent space embedding 404. The multi-image encoder may have any suitable configuration known in the art. Another major component of the LVFM includes pre-trained VFM 408 that is configured for projecting the multiple images embodied by latent space embedding 404 to high dimensional embeddings via continuous pretraining 406. Pre-trained VFM 408 may be configured as described further herein.

The LVFM may also include a branch of different downstream heads for different tasks (detection, segmentation, classification, etc.) that are learned through supervised finetuning (SFT) 410 or reinforcement learning, which may be performed in any suitable manner known in the art. For example, as shown in FIG. 4, the downstream heads may include object detection downstream head 412, digital twin downstream head 414, classification downstream head 416, segmentation downstream head 418, and mode selection downstream head 420, each of which may be configured as described further herein.

The learning data used in both of the configurations described above may be the same. For example, the process of training data preparation for both VFM and LVFM may be the same considering that both methodologies are following pretraining and fine-tuning (e.g., SFT) paradigms. The learning data may include a relatively large amount of unlabeled data (inputs without ground truth) and a relatively small amount of labeled data (inputs with ground truth).

Here, the inputs refer to the images from one or more different optical modes, one or more different design layers, one or more different prior layers, etc. Specifically, as described further herein, VFM only accepts inputs in image formats, while the LVFM has no constraints for the format of the inputs such as other process parameters.

The learning process may include two major stages: pre-training VFM or LVFM and fine-tuning for downstream applications. In one embodiment, the computer system is configured for pre-training an initial VFM from scratch with unlabeled training images through self-supervised learning thereby generating the pre-trained VFM. In another embodiment, the computer system is configured for pre-training an initial VFM from pre-trained parameters with unlabeled training images through self-supervised learning thereby generating the pre-trained VFM. For example, in stage 1, the computer system may pre-train the VFM either from scratch or with pretrained parameters with the generated multiple images through self-supervised learning. This stage aims to extract features and representations from images, capturing general patterns and structures. The relatively huge amount of unlabeled data may be used in this stage.

In a further embodiment, the computer system is configured for pre-training an initial VFM thereby generating the pre-trained VFM and fine-tuning the one or more components with labeled training data. For example, in stage 2 of the learning process, the computer system may fine-tune or adapt the pretrained model for different downstream tasks with the relatively small amount of labeled data.

In one such embodiment, the fine-tuning includes fixing the pre-trained VFM to extract the high dimensional embeddings of the labeled training data and only fine-tuning parameters of determining the information. In another such embodiment, the fine-tuning includes modifying one or more pre-trained parameters of the pre-trained VFM and one or more parameters of determining the information. For example, for VFM, pre-training is straightforward in stage 1. In stage 2, the pre-trained model may be fixed to extract the embeddings and only the parameters may be fine-tuned. An alternative way is to update both the pre-training and SFT.

In some embodiments, the one or more components include a pre-trained multi-image encoder and a pre-trained LVFM configured as described above, and the computer system is configured for simultaneously training an initial multi-image encoder and an initial LVFM together through self-supervised learning thereby generating the pre-trained multi-image encoder and the pre-trained LVFM. For example, for LVFM, there are different training options. In stage 1, the computer system may simultaneously train the encoder and VFM together through self-supervised learning.

In stage 2, there are 3 options. In one such embodiment, the computer system is configured for fine-tuning the one or more components by modifying one or more parameters of the pre-trained multi-image encoder, the pre-trained LVFM, and determining the information. In this manner, in the first option, the computer system may update all the parameters for all three components including the encoder, VFM, and fine-tuning.

In another such embodiment, the computer system is configured for fine-tuning the one or more components by fixing the pre-trained LVFM and only fine-tuning parameters of the pre-trained multi-image encoder and determining the information. As such, in the second option, the computer system may fix the VFM and update the parameters for the encoder and fine-tuning.

In a further such embodiment, the computer system is configured for fine-tuning the one or more components by fixing the pre-trained multi-image encoder and the pre-trained LVFM and only fine-tuning parameters of determining the information. In the third option, then, the computer system may fix both the encoder and VFM and only update fine-tuning.

Although the embodiments described herein may be configured for performing each of the pre-training and fine-tuning steps described above, the embodiments described herein do not need to be configured to perform any or all of these steps. In other words, although it may be advantageous for the same computer system to perform all of the pretraining and fine-tuning steps described above, one system or method may perform the pretraining, and the embodiments described herein may perform the fine-tuning. In another example, one system or method may perform the pretraining and fine-tuning described above, and the embodiments described herein may be configured for only performing inference using the pretrained and fine-tuned components. Therefore, the embodiments described herein may be configured only for runtime steps, while other systems or methods perform the setup type steps. In any case, each of the pretraining and fine-tuning steps described above may be performed in any suitable manner described herein.

The inference steps may include preparing the inputs, which maintains the same input formats as in the training stage. All the parameters for the entire network may be fixed, and then the inputs may be passed through the whole network. The predictions from the downstream tasks may be taken as the specimen information (e.g., the detection results).

The embodiments described herein have a number of advantages described further above and summarized again here. For example, the embodiments described herein can support transformer learning on multi-mode optical data. The embodiments described herein can also support arbitrary numbers of modes beyond just one single mode. In addition, the embodiments described herein can support images from different optical modes, different design layers, and different prior layers. Some of the embodiments described herein can support formats of inputs other than (and in addition to) images such as process parameters. The embodiments described herein further support a pre-trained model. Another advantage of the embodiments described herein is that they support different downstream tasks with relatively limited labeled data. Additionally, the embodiments described herein can support iterative updating for the model. Furthermore, the embodiments described herein can support mode selection. The embodiments described herein also provide multiple combinations of choices (by freezing some components) to train the model considering the available real computer resources (GPU nodes).

The advantages of the embodiments described above are provided by a number of important new features. One of such features is the use of GenAI technology and performing end-to-end downstream applications like defect detection for semiconductor imaging. Another such new feature is that the embodiments can be generalizable to different data across tools and across wafers. An additional new feature is that the embodiments have no restrictions on the number of input modes. A further new feature is that the embodiments can support different downstream tasks for defect detection such as detection, sematic segmentation, and instance segmentation as well as the other tasks described herein.

The embodiments described herein can also be implemented on a variety of different imaging systems including existing 39xx/29xx inspection tools commercially available from KLA in addition to other and future inspection tools. The embodiments described herein have the potential to advantageously change the way inspection and metrology problems are solved by GenAI methodology. In addition, the embodiments described herein can add value to current and future inspection tools by improving the sensitivity that those tools can achieve.

The computer system may be configured for storing a variety of information generated by the embodiments described herein. For example, the computer system may be configured for storing the one or more components, the selected mode(s), and/or any other results described herein for use during a process performed on the specimen such as those described herein. The computer system may be configured to store such one or more components and/or information in a recipe or by generating a recipe for the process in which the one or more components and/or information will be used. A “recipe” as that term is used herein is defined as a set of instructions that can be used by a tool to perform a process on a specimen. In this manner, generating a recipe may include generating information for how a process is to be performed, which can then be used to generate the instructions for performing that process. The computer system may also store any information that can be used to identify, access, and/or use the one or more components and/or information (e.g., such as a file name and where it is stored). The information for the one or more components that is stored may also include the code, instructions, algorithms, etc. for the one or more components. The one or more components and/or information may be stored in any suitable manner in any of the computer-readable storage media described herein.

The one or more components and/or information may be stored with any of the other results described herein and may be stored in any manner known in the art. The storage medium may include any storage medium described herein or any other suitable storage medium known in the art. After the one or more components and/or information has been stored, the one or more components and/or information can be accessed in the storage medium and used by any of the method or system embodiments described herein, formatted for display to a user, used by another software module, method, or system, etc. For example, the embodiments described herein may generate an inspection recipe as described above. That inspection recipe may then be stored and used by the system or method (or another system or method) to inspect the specimen or other specimens to thereby generate information (e.g., defect information) for the specimen or other specimens. The computer system may also be configured for generating information for a specimen as described herein, e.g., detecting defects on a specimen as described herein, and information generated by the computer system for the detected defects may be stored and used as described further herein.

Results and information generated by performing the process on the specimen or other specimens of the same type may be used in a variety of manners by the embodiments described herein and/or other systems and methods. Such functions include, but are not limited to, altering a process such as a fabrication process or step that was or will be performed on the specimen or another specimen in a feedback or feedforward manner. For example, the computer system may be configured to determine one or more changes to a process that was performed on a specimen inspected as described herein and/or a process that will be performed on the specimen based on the detected defect(s). The changes to the process may include any suitable changes to one or more parameters of the process. The computer system preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer system may determine such changes in any suitable manner known in the art.

Those changes can then be sent to a semiconductor fabrication system (not shown) or a storage medium (not shown) accessible to the computer system(s) and the semiconductor fabrication system. The semiconductor fabrication system may or may not be part of the system embodiments described herein. For example, the computer system and/or imaging system described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

As described herein, therefore, the embodiments can be used to setup a new inspection, metrology, etc. process or recipe. The embodiments may also be used to modify an existing inspection, metrology, etc. process or recipe, whether that is a process or recipe that was used for the specimen or was created for one specimen and is being adapted for another specimen.

The embodiments described herein are not limited to inspection recipe or process creation or modification. For example, the embodiments described herein can also be used to setup or modify a recipe or process for metrology, defect review, etc. in a similar manner. In particular, the one or more components described herein can be trained depending on the process that is being setup or revised.

Each of the embodiments described above may be combined together into one single embodiment. In other words, unless otherwise noted herein, none of the embodiments are mutually exclusive of any other embodiments.

Another embodiment relates to a computer-implemented method for determining information for a specimen. The method includes inputting multiple images for a specimen into a pre-trained VFM configured for projecting the multiple images to high dimensional embeddings via continuous pre-training. The multiple images include an image generated for the specimen with one or more modes of an imaging system. The method also includes determining information for the specimen from the high dimensional embeddings. The inputting and determining are performed by a computer system. One or more components are executed by the computer system, and the one or more components include the pre-trained VFM.

Each of the steps of the method may be performed as described further herein. The method may also include any other step(s) that can be performed by the inspection system and/or computer system described herein. In addition, the method described above may be performed by any of the system embodiments described herein.

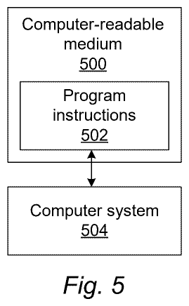

An additional embodiment relates to a non-transitory computer-readable medium storing program instructions executable on a computer system for performing a computer-implemented method for determining information for a specimen. One such embodiment is shown in FIG. 5. In particular, as shown in FIG. 5, non-transitory computer-readable medium 500 includes program instructions 502 executable on computer system 504. The computer-implemented method may include any step(s) of any method(s) described herein.

Program instructions 502 implementing methods such as those described herein may be stored on computer-readable medium 500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMID Extension), Python, Tensorflow, or other technologies or methodologies, as desired.

Computer system 504 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
a computer system; and
one or more components executed by the computer system, wherein the one or more components comprise:
a pre-trained vision foundation model (VFM) configured for projecting multiple images for a specimen to high dimensional embeddings via continuous pretraining, wherein the multiple images comprise an image generated for the specimen with one or more modes of an imaging system; and
one or more additional components configured for determining information for the specimen from the high dimensional embeddings.

2. The system of claim 1, wherein the pre-trained VFM is further configured for accepting only inputs in image formats.

3. The system of claim 1, wherein the multiple images further comprise multi-mode images generated for the specimen with multiple modes of the imaging system.

4. The system of claim 1, wherein the one or more components further comprise an image packing component configured for generating a single image that contains information from the multiple images.

5. The system of claim 4, wherein the multiple images further comprise multi-mode images generated for the specimen with multiple modes of the imaging system.

6. The system of claim 4, wherein the multiple images further comprise at least one of an image of a design layer on the specimen and an image of a layer formed on the specimen before a last layer formed on the specimen prior to generation of the image generated with the one or more modes of the imaging system.

7. The system of claim 1, wherein the multiple images further comprise the image generated for the specimen with the one or more modes of the imaging system and at least one image generated from design data for the specimen.

8. The system of claim 7, wherein the image generated for the specimen with the one or more modes of the imaging system and the at least one image generated from the design data for the specimen are generated for the same layer on the specimen.

9. The system of claim 7, wherein the image generated for the specimen with the one or more modes of the imaging system and the at least one image generated from the design data for the specimen are generated for different layers on the specimen.

10. The system of claim 1, wherein the pre-trained VFM is further configured as a pre-trained latent VFM (LVFM) having no constraints on formats of inputs into the pre-trained LVFM.

11. The system of claim 1, wherein the one or more components further comprise a multi-image encoder configured for projecting the multiple images into a latent space embedding.

12. The system of claim 11, wherein the multiple images further comprise at least one of information for a design layer on the specimen and information for a layer formed on the specimen before a last layer formed on the specimen prior to generation of the image generated with the one or more modes of the imaging system.

13. The system of claim 1, wherein the computer system is configured for pre-training an initial VFM from scratch with unlabeled training images through self-supervised learning thereby generating the pre-trained VFM.

14. The system of claim 1, wherein the computer system is configured for pre-training an initial VFM from pre-trained parameters with unlabeled training images through self-supervised learning thereby generating the pre-trained VFM.

15. The system of claim 1, wherein the computer system is configured for pre-training an initial VFM thereby generating the pre-trained VFM and fine-tuning the one or more components with labeled training data.

16. The system of claim 15, wherein the fine-tuning comprises fixing the pre-trained VFM to extract the high dimensional embeddings of the labeled training data and only fine-tuning parameters of said determining information.

17. The system of claim 15, wherein the fine-tuning comprises modifying one or more pre-trained parameters of the pre-trained VFM and one or more parameters of said determining information.

18. The system of claim 1, wherein the one or more components further comprise a pre-trained multi-image encoder configured for projecting the multiple images into a latent space embedding, wherein the pre-trained VFM is further configured as a pre-trained latent VFM (LVFM), and wherein the computer system is configured for simultaneously training an initial multi-image encoder and an initial LVFM together through self-supervised learning thereby generating the pre-trained multi-image encoder and the pre-trained LVFM.

19. The system of claim 18, wherein the computer system is further configured for fine-tuning the one or more components by modifying one or more parameters of the pre-trained multi-image encoder, the pre-trained LVFM, and said determining information.

20. The system of claim 18, wherein the computer system is further configured for fine-tuning the one or more components by fixing the pre-trained LVFM and only fine-tuning parameters of the pre-trained multi-image encoder and said determining information.

21. The system of claim 18, wherein the computer system is further configured for fine-tuning the one or more components by fixing the pre-trained multi-image encoder and the pre-trained LVFM and only fine-tuning parameters of said determining information.

22. The system of claim 1, wherein the one or more additional components are further configured for learning by supervised fine-tuning.

23. The system of claim 1, wherein the one or more additional components are further configured for learning by reinforcement learning.

24. The system of claim 1, wherein determining the information comprises detecting defects on the specimen based on the high dimensional embeddings.

25. The system of claim 1, wherein determining the information comprises generating a digital twin of a manufacturing process performed on the specimen prior to generation of the image generated with the one or more modes of the imaging system based on the high dimensional embeddings.

26. The system of claim 1, wherein determining the information comprises classifying defects detected on the specimen based on the high dimensional embeddings.

27. The system of claim 1, wherein determining the information comprises segmenting one or more of the multiple images based on the high dimensional embeddings.

28. The system of claim 1, wherein determining the information comprises selecting one or more modes of the imaging system for a process performed on the specimen or another specimen based on the high dimensional embeddings.

29. A non-transitory computer-readable medium, storing program instructions executable on a computer system for performing a computer-implemented method for determining information for a specimen, wherein the computer-implemented method comprises:
inputting multiple images for a specimen into a pre-trained vision foundation model (VFM) configured for projecting the multiple images to high dimensional embeddings via continuous pretraining, wherein the multiple images comprise an image generated for the specimen with one or more modes of an imaging system; and
determining information for the specimen from the high dimensional embeddings, wherein the pre-trained VFM is included in one or more components executed by the computer system.

30. A computer-implemented method for determining information for a specimen, comprising:
inputting multiple images for a specimen into a pre-trained vision foundation model (VFM) configured for projecting the multiple images to high dimensional embeddings via continuous pretraining, wherein the multiple images comprise an image generated for the specimen with one or more modes of an imaging system; and
determining information for the specimen from the high dimensional embeddings, wherein said inputting and said determining are performed by a computer system, wherein one or more components are executed by the computer system, and wherein the one or more components comprise the pre-trained VFM.
